(19) United States
(12) Patent Application Publication
(10) Pub. No.: US 2017/0269704 A1
(43) Pub. Date: Sep. 21, 2017

(54) DISPLAY DEVICE FOR VEHICLE

(71) Applicant: HONDA MOTOR CO., LTD., Tokyo (JP)

(72) Inventors: Tatsuya Akita, Wako-shi (JP); Toru Yoneno, Wako-shi (JP); Yasuhiro Miyachi, Wako-shi (JP)

(73) Assignee: HONDA MOTOR CO., LTD., Tokyo (JP)

(21) Appl. No.: 15/459,320

(22) Filed: Mar. 15, 2017

(30) Foreign Application Priority Data
Mar. 15, 2016 (JP) 2016-051333

(51) Int. Cl. G06F 3/02; B60K 37/06; G01C 21/36; G06F 3/14

(52) U.S. Cl. CPC G06F 3/02; G06F 3/1423; B60K 37/06; G01C 21/3664; G01C 21/3667; G06F 3/0482

(57) ABSTRACT

A display device 10 of a vehicle includes a first display section 15, a second display section 16, a steering switch 11, a vehicle speed sensor 12, and a control device 17. The first display section 15 displays at least a map. The second display section 16 displays information for operating a display content of the first display section 15. The steering switch 11 receives an operation input of an operator of the vehicle 1. The vehicle speed sensor 12 detects speed of the vehicle. The control device 17 displays information of an operation state of the steering switch 11 on the second display section 16 when the vehicle speed which is detected by the vehicle speed sensor 12 is larger than a threshold value.

### CROSS-REFERENCE OF RELATED APPLICATION

This application claims priority of Japanese Patent Application No. 2016-051333 filed in Japan on Mar. 15, 2016, the entire contents of which are incorporated herein by reference.

### TECHNICAL FIELD

The present invention relates to a display device for a vehicle.

### BACKGROUND OF THE INVENTION

Hitherto, when displaying a plurality of different screens in a single display, there is known a navigation system that a plurality of screens are displayed in a superimposing manner (for example, see Japanese Patent Application Laid-Open Publication No. 2010-173374). In this navigation system, when switching a map screen to another screen, for example, an operation screen for operating a change of the screen is superimposed and displayed on the map screen.

Further, hitherto, there is known a display device for a vehicle that different screens from each other are displayed on a plurality of displays (for example, see Japanese Patent Application Laid-Open Publication No. 2007-076381). In this display device for the vehicle, a screen which places priority on visibility and a screen which places priority on operability are displayed on two displays, for example.

### SUMMARY OF INVENTION

By the way, according to the navigation systems in accordance with the prior art, since the plurality of different screens are displayed in a superimposed manner, there causes a problem in that an operator cannot visually confirm the whole of each of the screens properly. For example, when the operation screen is superimposed on the map screen during traveling of the vehicle, there causes a problem in that the operator cannot visually confirm the map.

Further, the display device for the vehicle in accordance with the prior art is provided with a steering switch for operating a switch or button, etc. to be displayed on the screen which places priority on the operability. However, it is difficult for the operator to carefully observe the screen which places priority on the operability, during traveling of the vehicle, so that there causes a problem in that it is difficult for the operator to confirm, from the screen which places priority on the operability, whether or not the steering switch is operated properly.

The present invention therefore has been made in consideration of the above described problems and has an objective of providing a display device for a vehicle which can easily confirm a state of an operation part for operating display contents of each of screens while ensuring visibility with respect to the plurality of screens.

To achieve the object while solving the above mentioned problem, the present invention has the following modes.

(1) A display device for a vehicle according to a first mode of the present invention comprises a first display section (for example, a first display section 15 in an embodiment) for displaying at least a map, a second display section (for example, a second display section 16 in the embodiment) for displaying information for operating a display content of the first display section, an operation section (for example, a steering switch 11, a selection lever 50 in the embodiment) being arranged in a position other than the vicinity of the first display section and other than the vicinity of the second display section and receiving an operation input of an operator, a vehicle speed detection section (for example, a vehicle speed sensor 12 in the embodiment) for detecting speed of the vehicle, and a control section (for example, a control device 17 in the embodiment) for displaying information of an operation state of the operation section on the second display section when the vehicle speed which is detected by the vehicle speed detection section is larger than a threshold value.

(2) In the display device for the vehicle described in the above item (1), the operation section is a switch (for example, the steering switch 11 in the embodiment) arranged in a steering wheel of the vehicle.

(3) In the display device for the vehicle described in the above item (2), the control section highlights and displays an actual operation state among a plurality of operation states.

(4) In the display device for the vehicle described in any one of the above item (1) to (3), the second display section is arranged in a position which is visually confirmed more easily than the first display section by the operator of the vehicle.

(5) In the display device for the vehicle described in any one of the above items (1) to (4), the control section controls a display content of the second display section such that the display content falls within a range of a single screen.

(6) In the display device for the vehicle described in the above (5), the control section allows the second display section to display a list of destination histories.

(7) In the display device for the vehicle described in the above item (5) or (6), the control section allows the second display section to display a list of registered points.

(8) In the display device for the vehicle described in any one of the above items (5) to (7), the control section allows the first display section to display a map around a position displayed by the second display section.

(9) In the display device for the vehicle described in any one of the above items (1) to (8), the control section allows the second display section to display an operation guide for telephonic communication at the time of an incoming call of a telephone (for example, a cellular phone 24 in the embodiment) operable through the operation section.

(10) In the display device for the vehicle described in any one of the above items (1) to (9), the control section allows the display content of the first display section and the display content of the second display section to be exchanged and displayed when the speed of the vehicle detected by the vehicle speed detection section is smaller than or equal to the threshold value.

(11) A display device for a vehicle according to another mode of the present invention comprises a first display section for displaying at least a map, a second display section for displaying information for operating a display content of the first display section, an operation section in the form of switch being arranged in a steering wheel and receiving an operation input of an operator of the vehicle, and a control section for displaying information of an operation state of the operation section on the second display section, in the form of substantially a switch.

### Effect of the Invention

The display device of the vehicle according to the mode described in the above item (1) has the control device for displaying the information of an operation state of the operation section on the second display section during traveling of the vehicle. Therefore, the operation state of the operating section can be easily confirmed by the operator while ensuring visibility relative to the display content such as the map of the first display section and the like.

Further, in the case of the above item (2), even when it is difficult for the operator during operation of the vehicle to visually confirm directly the operation state of the switch arranged in the steering wheel, the operation state of the operation section can be easily confirmed through the second display section by the operator.

Further, in the case of the above item (3), since the control section highlights and displays the actual operation state of the switch, the operation state of the operation section can be easily confirmed by the operator even during the operation of the vehicle.

Further, in the case of the above item (4), since the second display section is arranged in the position which is visually confirmed more easily than the first display section by the operator, the operation state of the operation section can be easily confirmed by the operator even during the operation of the vehicle.

Further, in the case of the above item (5), the control section controls the display content of the second display section such that the display content falls within a range of the single screen. Therefore, in comparison with the case where a screen feed or scrolling, for example, is required, it is possible to prevent the operator's attention from becoming distracted, and an increase in movement of line of sight can be prevented.

Further, in the case of the above item (6), the list of the destination histories is displayed in such a manner as to fall within a range of the single screen. Therefore, at the time of setting the destination, etc., it is possible to prevent the operator's attention from becoming distracted, and the increase in movement of line of sight can be prevented.

Further, in the case of the above item (7), the list of the registered points is displayed in such a manner as to fall within a range of the single screen. Therefore, at the time of setting the destination, etc., it is possible to prevent the operator's attention from becoming distracted, and the increase in movement of line of sight can be prevented.

Further, in the case of the above item (8), since the map around the position such as the destination or the registered point or the like displayed by the second display section is displayed on the first display section, it is possible to easily ensure the visibility relative to the map, and the position can be easily grasped by the operator.

Further, in the case of the above item (9), since the control section allows the second display section to display the operation guide for telephonic communication at the time of the incoming call of the telephone, the telephone can be easily operated by the operation section without getting the operator confused even when operating the vehicle.

Further, in the case of the above item (10), when the operator can afford to visually confirm directly the operation state of the operation section at the time of stopping the vehicle, etc., the information other than the operation state of the operation section can be displayed on the second display section by exchanging the display content of the first display section and the display content of the second display section.

In the case of the above item (11), even when it is difficult for the operator during operation of the vehicle to visually confirm directly the operation state of the switch arranged in the steering wheel, the operation state of the operation section can be easily confirmed through the second display section by the operator. The word “section” used in this application may mean a physical part or component of computer hardware or any device including a controller, a processor, a memory, etc., which is particularly configured to perform functions and steps disclosed in the application.

### BRIEF DESCRIPTION OF THE DRAWINGS

FIG. 1 is a block diagram of a functional configuration of a display device for a vehicle in accordance with an embodiment of the present invention;

FIG. 2 is a view showing a steering switch provided in a steering wheel, a first display section and a second display section provided in an installment panel, in the display device for the vehicle in accordance with the embodiment of the present invention;

FIG. 3 is a perspective view showing in an enlarged scale the steering switch of the display device for the vehicle in accordance with the embodiment of the present invention;

FIG. 4 is a view showing an example of a home screen displayed on the first display section of the display device for the vehicle in accordance with the embodiment of the present invention;

FIG. 5 is a view showing an example of a navigation screen displayed on the first display section of the display device for the vehicle in accordance with the embodiment of the present invention;

FIG. 6 is a view showing an example of an audio screen displayed on the first display section of the display device for the vehicle in accordance with the embodiment of the present invention;

FIG. 7 is a view showing an example of a telephone screen displayed on the first display section of the display device for the vehicle in accordance with the embodiment of the present invention;

FIG. 8 is a view showing an example of a steering switch menu screen displayed on the second display section of the display device for the vehicle in accordance with the embodiment of the present invention, and showing a state where an item (Audio Menu) relative to an audio system of a main menu screen is selected;

FIG. 9 is a view showing an example of the steering switch menu screen displayed on the second display section of the display device for the vehicle in accordance with the embodiment of the present invention, and showing a state where an item (SCAN) relative to a scan of a source menu screen for audio is selected;

FIG. 10 is a view showing an example of a steering switch menu screen displayed on the second display section of the display device for the vehicle in accordance with the embodiment of the present invention, and showing a state where an item (Navigation Menu) relative to a navigation system of the main menu screen is selected;

FIG. 11 is a view showing an example of the steering switch menu screen displayed on the second display section of the display device for the vehicle in accordance with the embodiment of the present invention, and showing a state where an item relative to a destination history of a source menu screen for navigation is selected;

FIG. 12 is a view showing an example of a source menu screen for the destination history displayed on the second display section of the display device for the vehicle in accordance with the embodiment of the present invention, and showing a state where an item relative to a first destination is selected;

FIG. 13 is a view showing an example of the navigation screen displayed on the first display section by linking to source menu screen for the destination history displayed on the second display section of the display device for the vehicle in accordance with the embodiment of the present invention;

FIG. 14 is a view showing an example of a rear camera image screen displayed on the second display section of the display device for the vehicle in accordance with the embodiment of the present invention;

FIG. 15 is a view showing an example of an incoming call screen displayed on the second display section of the display device for the vehicle in accordance with the embodiment of the present invention;

FIG. 16 is a flow chart showing operation of the display device for the vehicle in accordance with the embodiment of the present invention; and

FIG. 17 is a view showing the steering switch provided in the steering wheel, and a plurality of display sections, in the display device for the vehicle in accordance with a modified embodiment of the present invention.

### DETAILED DESCRIPTION OF THE INVENTION

Hereunder, a display device for a vehicle in accordance with an embodiment of the present invention will be explained with reference to accompanying drawings.

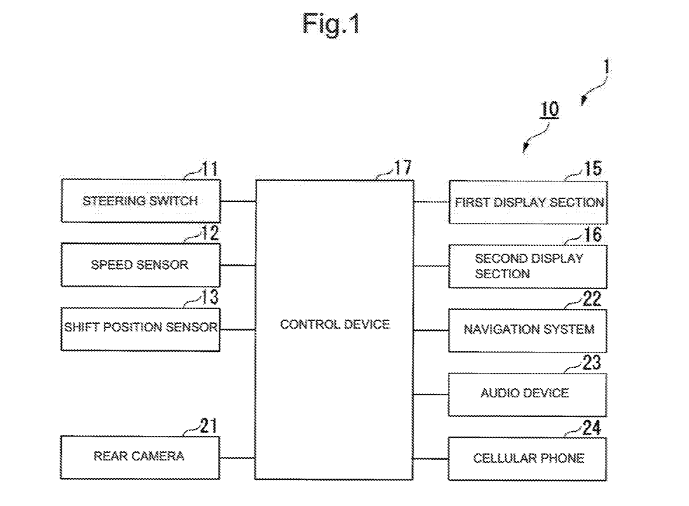

The display device 10 for the vehicle according to the embodiment is installed in the vehicle 1. The display device 10 for the vehicle, as shown in FIG. 1, includes a steering switch 11, a vehicle speed sensor 12, a shift position sensor 13, a first display section 15, a second display section 16 and a control device 17. The vehicle 1 is provided with, for example, a rear camera 21, a navigation system 22, an audio device 23, and a cellular phone 24 to be carried by the operator, in addition to the display device 10 for the vehicle.

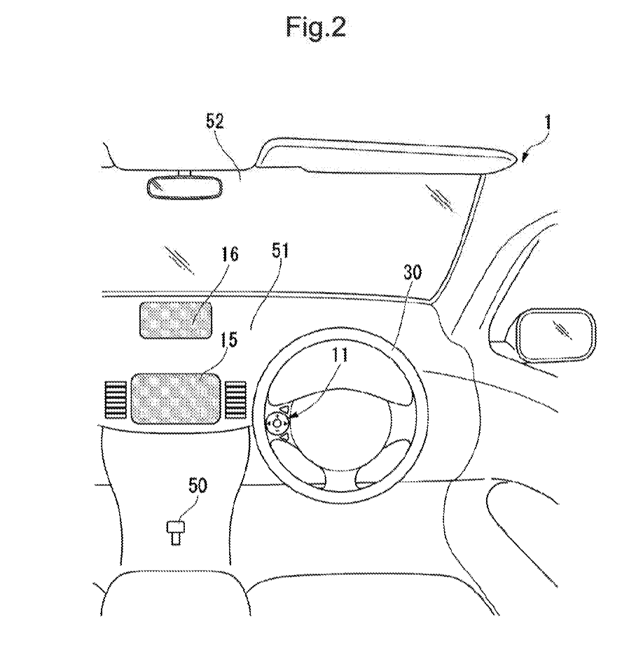

The steering switch 11, as shown in FIG. 2, is arranged in a steering wheel 30. The steering switch 11 functions as an input device which is located in a position operable by fingers of the operator who holds the steering wheel 30. The steering switch 11 is configured to output a signal responding to a pushing down operation by the fingers of the operator, for example.

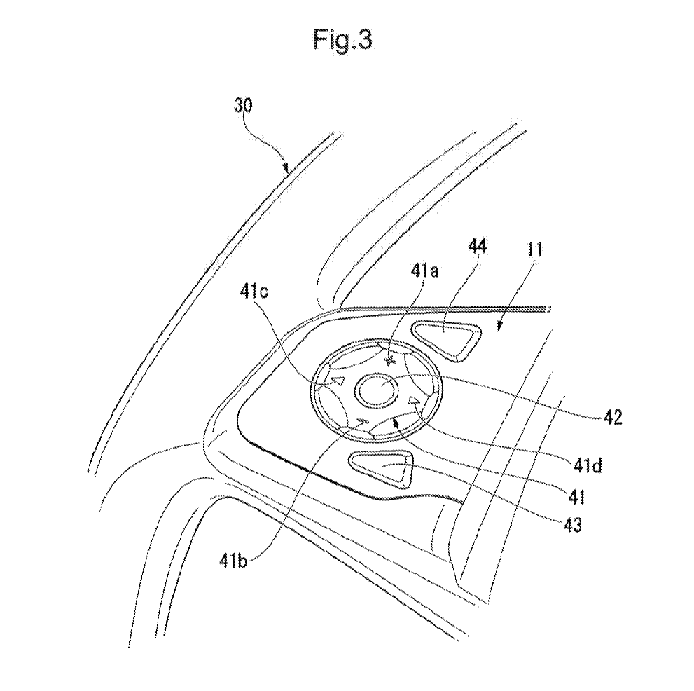

As shown in FIGS. 2 and 3, the steering switch 11 is provided with a cross key 41 and three push buttons as a plurality of operable parts, for example. The cross key 41 has a first switch (+) 41a indicating an upper direction, a second switch (−) 41b indicating a lower direction, a third switch (←) 41c indicating a left direction, and a fourth key (→) 41d indicating a right direction. The three push buttons are composed of a first push button (SOURCE) 42, a second push button (MENU) 43 and a third push button (DISP) 44. The first push button (SOURCE) 42 is located in a center portion of the cross key 41. The second push button (MENU) 43 and the third push button (DISP) 44 is located in the periphery of the cross key 41.

The vehicle speed sensor 12 detects the speed (vehicle speed) of the vehicle 1 thereby to output a signal of the vehicle speed. The vehicle speed sensor 12 detects the vehicle speed based on, for example, a signal of the rotational speed (wheel speed) of a wheel which is outputted from a wheel speed sensor.

The shift position sensor 13 outputs a signal of a shift position of the vehicle 1 which is selected by the operation of a selection lever 50 by the operator. The shift position, is composed, for example, of parking indicating a stop of the vehicle 1, a neutral indicating the neutralization, a reverse indicating a backward movement, a drive indicating a forward movement, etc.

The first display section 15, as shown in FIG. 2, is a liquid crystal display arranged in the center of an instrument panel 51. The first display section 15 is a touch panel which receives an input operation by the contact of the fingers of the operator, for example. The first display section 15 is configured to display at least a map of the navigation system 22.

The second display section 16 is a liquid crystal display which is located above the first display section 15 in the instrument panel 51. The second display section 16 is a touch panel which receives an input operation by the contact of the fingers of the operator, for example. The second display section 16 is arranged in a position capable of being visually confirmed more easily than the first display section 15 by the operator of the vehicle 1. As compared with the first display section 15, the second display section 16 is arranged in such a position that the operator during operating the vehicle 1 is visually confirmable by less movement of the sight line. As compared with the first display section 15, the second display section 16 is arranged, for example, in a position closer to a front glass 52 or in a position closer to a caution range in the forward direction of the operator in a proper driving position.

The control device 17 is a software function part which functions when a predetermined program is executed by the processer for example, such as CPU, etc. The control device 17 is an ECU (Electronic Control Unit) which has the processer such as CPU, etc., ROM for storing the program, RAM for memorizing data temporarily, and an electronic circuit such as timer and the like.

The control device 17 controls operation of each of the first display section 15, the second display section 16, the rear camera 21, the navigation system 22, the audio device 23 and the cellular phone 24.

The rear camera 21 images a predetermined range in the rear of the vehicle 1 and outputs an imaged image of the rear of the vehicle 1.

The navigation system 22 performs the detection of a current location of the vehicle 1, a route guide up to the destination and the like.

The audio device 23 outputs sound contents such as music, a sound track, and a broadcasting program or the like from a speaker.

The cellular phone 24 is a smartphone, etc. which the operator carry. The cellular phone 24 is connected to the control device 17, for example, by wireless connection by short distance wireless communication such as Bluetooth or by wire connection.

The control device 17 executes a first display mode when the vehicle speed to be detected by the vehicle speed sensor 12 during traveling of the vehicle 1 is larger than a predetermined threshold value. The control device 17 executes a second display mode when the vehicle speed to be detected by the vehicle speed sensor 12 is not larger than the predetermined threshold value, for example, at the time of stop of the vehicle 1, etc.

In the first display mode, the control device 17 displays an operation screen for performing various kinds of setting operations, on the first display section 15. The control device 17 controls the operation of each of the first display section 15, the second display section 16, the rear camera 21, the navigation system 22, the audio device 23 and the cellular phone 24, in response to the input operation of the operator to be received by the touch panel of the first display section 15 which displays the operation screen.

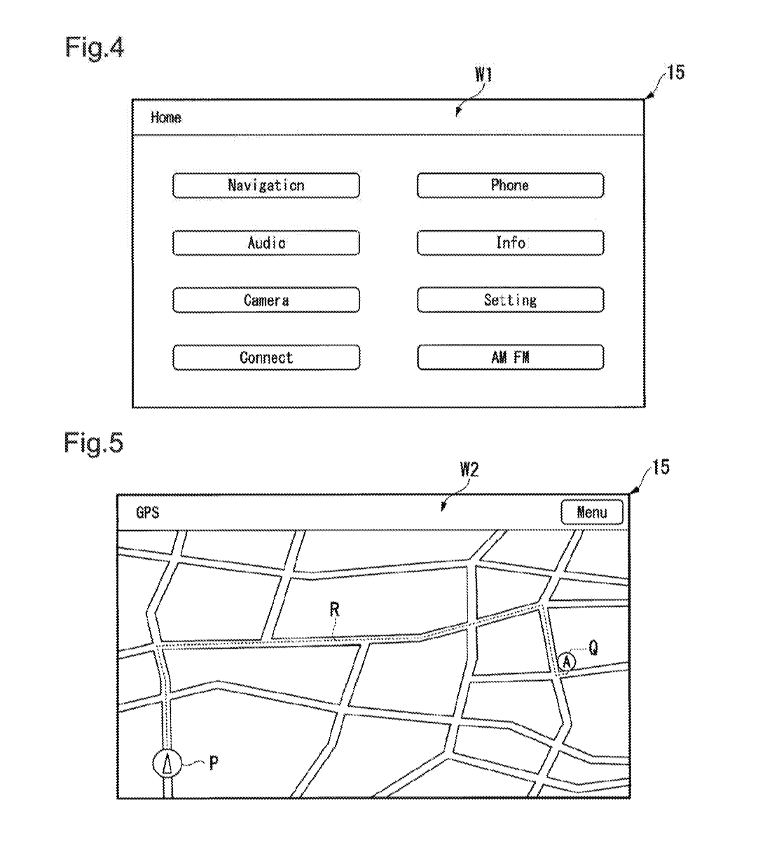

The control device 17, as shown in FIG. 4, displays a home screen W1 which is one of the operation screens, on the first display section 15 in the initial state. The home screen W1 is a screen of the highest hierarchy of the operation screen having the hierarchy configuration, to be displayed on the first display section 15. The home screen W1 has a plurality of items which are selectable by the touch panel of the first display section 15. The plurality of items include, for example, items relative to each of the rear camera 21, the navigation system 22, the audio device 23 and the cellular phone 24, items relative to various kinds of settings, the information, etc., and the like.

For example, when the item (Navigation) relative to the navigation system 22 is selected by the operator in the home screen W1 of the first display section 15, as shown in FIG. 5, the control device 17 switches the home screen W1 of the first display section 15 to a navigation screen W2 of the lower hierarchy. The navigation screen W2 has the map image indicating the current location P of the vehicle 1, the destination Q and the route R from the current location P to the destination Q, etc., a menu item for inputting various kinds of settings such as the destination Q, etc., and the like, for example.

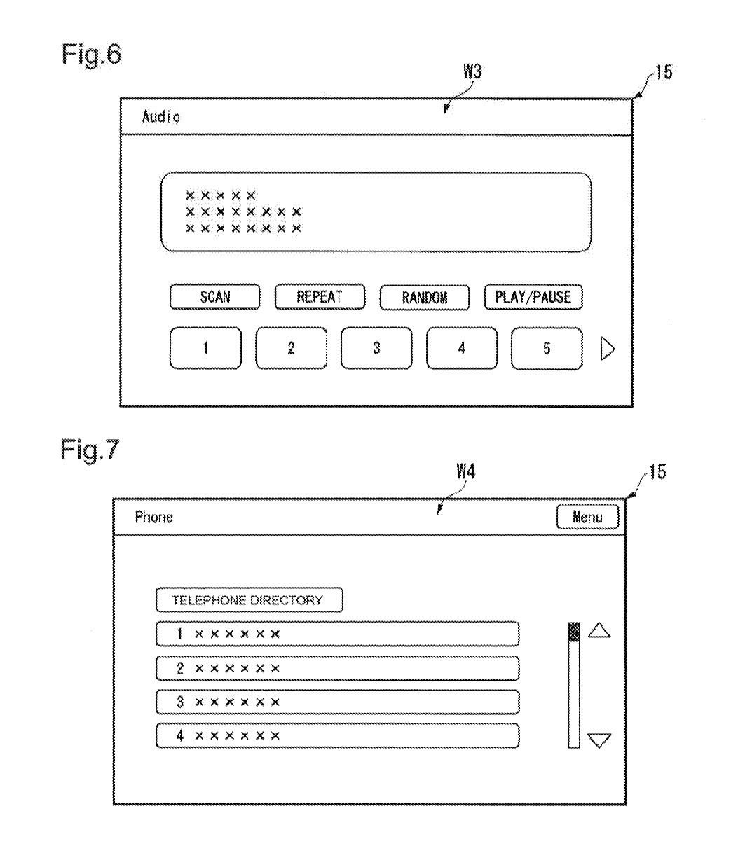

For example, when the item (Audio) relative to the Audio device 23 is selected by the operator in the home screen W1 of the first display section 15, as shown in FIG. 6, the control device 17 switches the home screen W1 of the first display section 15 to an audio screen W3 of the lower hierarchy. The audio screen W3 has, for example, the information of the selected sound contents, items for operating the sound contents, items for selecting a source of the sound contents, and the like.

For example, when the item (Phone) relative to the cellular phone 24 is selected by the operator in the home screen W1 of the first display section 15, as shown in FIG. 7, the control device 17 switches the home screen W1 of the first display section 15 to a telephone screen W4 of the lower hierarchy. The telephone screen W4 has, for example, an item of registered telephone number, a menu item for inputting various kinds of settings such as a telephone directory, and the like.

In the case where a prescribed key button for operating onboard equipment is provided in the instrument panel 51, the control device 17 controls the operation of each of the first display section 15, the second display section 16, the rear camera 21, the navigation system 22, the audio device 23 and the cellular phone 24, in response to the input operation of the operator to be received by the key button.

In the first display mode, the control device 17 displays any one of a resident screen, a steering switch menu screen and an interrupt screen on the second display section 16. Each of the screens displayed on the second display section 16 in the first display mode has a display content which falls within a single screen and does not correspond to, for example, a screen feed by a plurality of screens or scrolling which exceeds a range of the single screen.

The resident screen is displayed in the initial state. The resident screen has, for example, various kinds of information such as time, etc., the information relative to the display content of the first display section 15, and the like. When the third push button (DISP) 44 of the steering switch 11 is operated, the control device 17 switches the plurality of different resident screens successively and displays it on the second screen 16.

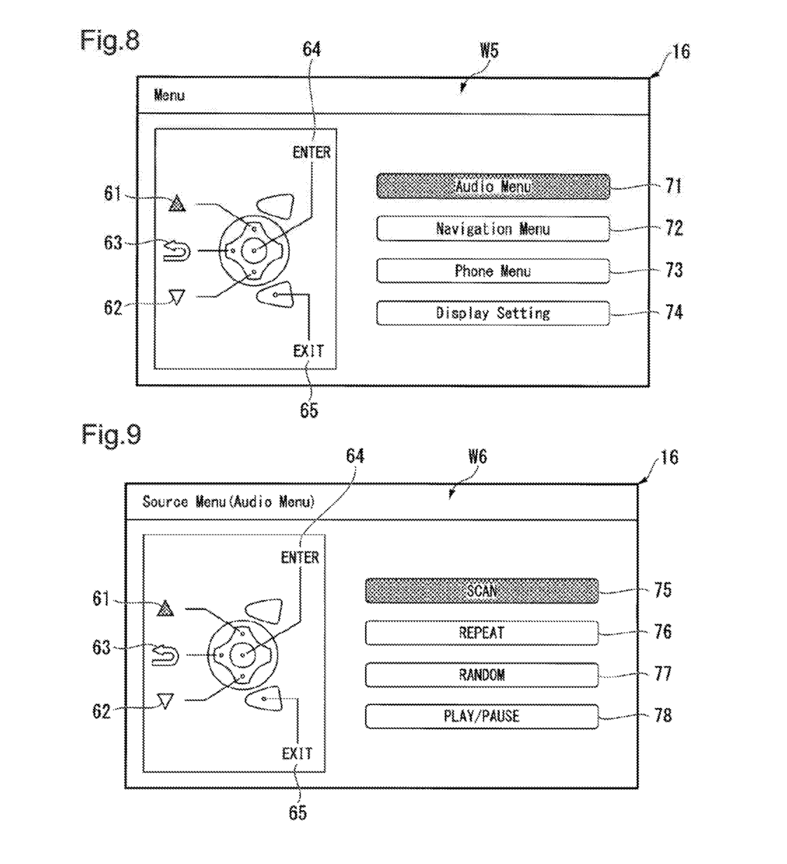

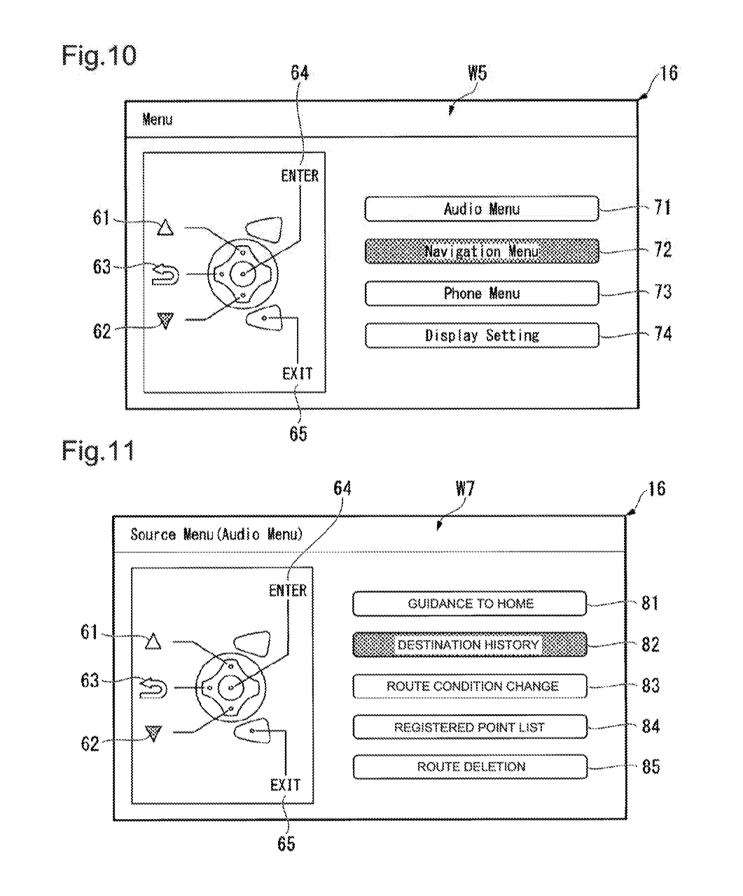

The steering switch menu screen is displayed when the second push button (MENU) 43 of the steering switch 11 is operated. As shown in FIGS. 8 to 12, the steering switch menu screen has a main menu screen W5 and source screens W6 to W8 in the form of hierarchy configuration. As shown in FIGS. 8 and 10, the main screen W5 is a screen of the highest hierarchy. As shown in FIGS. 9, 11 and 12, the source menu screens W6 to W8 are screens of lower hierarchy relative to the main menu screen W5.

The main menu screen W5 and the source screens W6 to W8 have the information of the operation contents corresponding to each of parts of the steering switch 11, the information of operation states of each of the parts of the steering switch 11, and items selected by the steering switch 11.

The information of the operation contents is the information for guiding by symbols or characters or the like the operation contents corresponding to each of the parts of the steering switch 11. The information of the operation contents has the symbols or the characters or the like corresponding to operable parts among each of the parts of the steering switch 11, in an image which indicates the steering switch 11. The information of the operation contents is the information for guiding, for example, the operation for selecting any one of a plurality of items, the operation for fixing the selected item, the operation for returning the screen displayed on the second display section 16 to the previous screen in time series, the operation for switching the steering switch menu screen displayed on the second display section 16 to the resident screen, and the like.

In the steering switch menu screens shown in FIGS. 8 to 12, the operable parts among each of parts of the steering switch 11 are, for example, the first switch (+) 41a, the second switch (−) 41b, the third switch (←) 41c, the first switch button (SOURCE) 42, and the second push button (MENU) 43.

The operation contents corresponding to the first switch (+) 41a are the operation for moving upward the selection among a plurality of items arranged in the upward and downward direction. A symbol 61 for guiding the operation contents of the first switch (+) 41a is, for example, a symbol indicating the upper direction.

The operation content corresponding to the second switch (−) 41b is the operation for moving downward the selection among the plurality of items arranged in the upward and downward direction. A symbol 62 for guiding the operation contents of the second switch (−) 41b is, for example, a symbol indicating the lower direction.

The operation content corresponding to the third switch (←) 41c is the operation for returning the screen displayed on the second display section 16 to the previous screen in time series. A symbol 63 for guiding the operation contents of the third switch (←) 41c is, for example, a symbol of a curved arrow.

The operation content corresponding to the first push button (SOURCE) 42 is the operation for fixing the item selected by the first switch (+) or the second switch (−) 41b. Characters 64 for guiding the operation contents of the first push button (SOURCE) 42 are characters such as “ENTER”, for example.

The operation content corresponding to the second push button (MENU) 43 is the operation for switching the steering switch menu screen displayed on the second display section 16 to the resident screen. Characters 65 for guiding the operation contents of the second push button (MENU) 43 are, for example, characters of “EXIT”.

The information of the operation state is the information indicating whether or not each of the parts of the steering switch 11 is actually operated. The information of the operation state indicates whether or not each of the parts of the steering switch is actually operated by existence or nonexistence of highlighting display relative to the information of the operation state corresponding to each of the parts of the steering switch 11, for example.

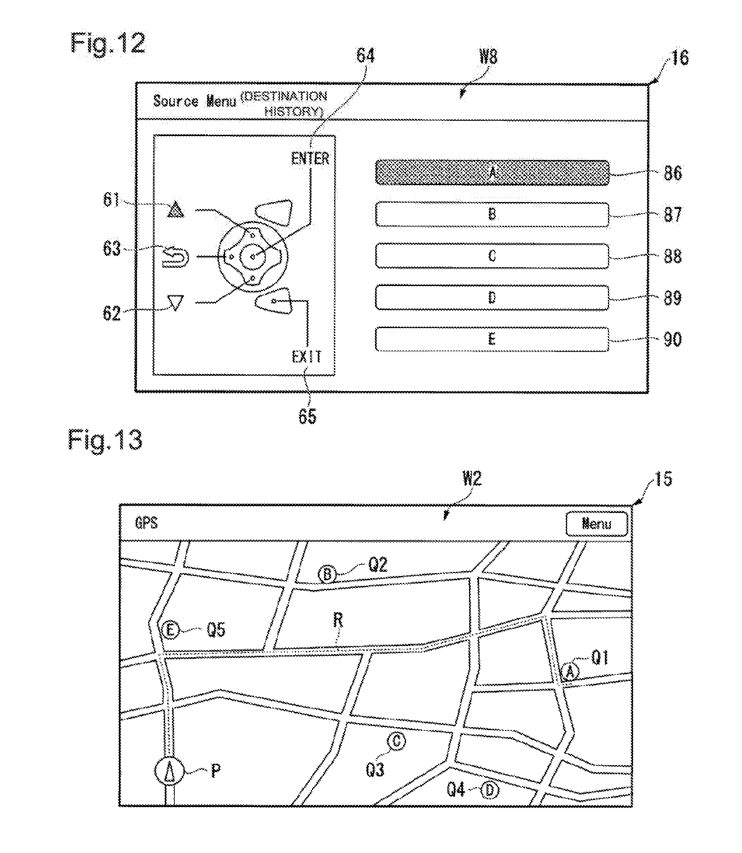

In the main menu screen W5 shown in FIG. 8 and each of the source menu screens W6, W8 shown in FIGS. 9 and 12, the information (for example, the symbol 61 indicating the upper direction) of the operation state corresponding to the first switch (+) 41a is highlighted and displayed, so that it is indicated that the first switch (+) 41a is actually operated.

In the main menu screen W5 shown in FIG. 10 and the source menu screen W7 shown in FIG. 11, the information (for example, the symbol 62 indicating the lower direction) of the operation state corresponding to the second switch (−) 41b is highlighted and displayed so that the state in which the second switch (−) 41b is actually operated is indicated.

The items to be selected by the steering switch 11 in the main menu screen W5 of the highest hierarchy, as shown in FIGS. 8 and 10 are items 71 to 74 for controlling each of the first display section 15, the second display section 16, the navigation system 22, the audio device 23 and the cellular phone 24. The control device 17 controls at least a part of operations of each of the first display section 15, the second display section 16, the navigation system 22, the audio device 23 and the cellular phone 24, in response to the input of the operator which is received by the steering switch 11.

As shown in FIG. 8, when the item (Audio Menu) 71 relative to the audio device 23 in the main menu screen W5 is selected by the operation of the first switch (+) 41a of the steering switch 11, the control device 17 highlights and displays the selected item 71 together with the symbol 61.

As shown in FIG. 9, when the selection of the item 71 is fixed by the operation of the first push button (SOURCE) 42 of the steering switch 11, the control device 17 switches the main menu screen W5 of the second display section 16 to the audio source menu screen W6 of the lower hierarchy.

Items 75 to 78 to be selected by the steering switch 11 in the audio source menu screen W6 are items for operating the sound contents. The items for operating the sound contents are the item 75 relative to a scan of the sound contents, the item 76 relative to a repeating output of the sound contents, the item 77 relative to a random output of the sound contents, the item 78 relative to output execution or output stop of the sound contents, and the like, for example.

As shown in FIG. 9, when the item 75 relative to the scan of the sound contents in the audio source menu screen W6 is selected by the operation of the first switch (+) 41a of the steering switch 11, the control device 17 highlights and displays the selected item 75 together with the symbol 61.

As shown in FIG. 10, when the item (Navigation Menu) 72 relative to the navigation system 22 in the main menu screen W5 is selected by the operation of the second switch (−) 41b of the steering switch 11, the control device 17 highlights and displays the selected item 72 together with the symbol 62.

As shown in FIG. 11, when the selection of the item 72 is fixed by the operation of the first push button (SOURCE) 42 of the steering switch 11, the control device 17 switches the main menu screen W5 of the second display section 16 to the navigation source menu screen W7 of the lower hierarchy.

Items to be selected by the steering switch 11 in the navigation source menu screen W7 are items for operating the various kinds of settings. The items for operating the various kinds of settings are an item 81 relative to a guidance to home, an item 82 relative to a history of destinations, an item 83 relative to a route condition change of the route guide, an item 84 relative to a registered point list, an item 85 relative to a route deletion of the route guide, and the like, for example.

As shown in FIG. 11, when the item (destination history) 82 relative to the history of destinations in the navigation source menu screen W7 is selected by the operation of the second switch (−) 41b of the steering switch 11, the control device 17 highlights and displays the selected item 82 together with the symbol 62. As shown in FIG. 12, when the selection of the item 82 is fixed by the operation of the first push button (SOURCE) 42 of the steering switch 11, the control device 17 switches the navigation source menu screen W7 of the second display section 16 to the destination history source menu screen W8 of the lower hierarchy.

Items to be selected by the steering switch 11 in the destination history source menu screen W8 are items 86 to 90 relative to the history of the destinations. The items 86 to 90 relative to the history of the destinations are items relative to the latest destinations of the predetermined number or the destinations of the predetermined number in order of high frequency in setting, for example.

When the destination history source menu is displayed on the second display section 16 as shown in FIG. 12, the control device 17 switches the screen displayed on the first display section 15 to the navigation screen W2 as shown in FIG. 13. The navigation screen W2 shown in FIG. 13 has the current location P of the vehicle 1, five destinations Q1 to Q5 displayed on the destination history source menu screen W8, a map image indicating the route R, etc. from the current location P to the first destination Q1, menu items for inputting various kinds of settings such as the destination, etc., and the like, for example.

As shown in FIG. 12, when the item (A) 86 relative to a first destination in the destination history source menu screen W8 is selected by the operation of the first switch (+) 41a of the steering switch 11, the control device 17 highlights and displays the selected item 86 together with the symbol 61.

As shown in FIG. 13, when the selection of the item 86 is fixed by the operation of the first push button (SOURCE) 42 of the steering switch 11, the control device 17 displays a map image in the periphery of the first destination Q1 and the route R from the current location P to the first destination Q1 on the first display section 15.

When items other than the item 82 relative to the destination history are selected in the navigation source menu screen W7, the control device 17 displays a source menu screen corresponding to each of the items on the second display section 16.

When the source menu screen corresponding to each of the items 81 to 85 of the navigation source menu screen W7 is displayed on the second display section 16, the control device 17 displays the navigation screen W2 on the first display section 15. The navigation screen W2 has the map image corresponding to the source menu screen displayed on at least the second display section 16.

In the case of displaying the source menu screen corresponding to the item 81 relative to the guidance to home on the second display section 16, the control device 17 displays on the first display section 15 a map image which has a plurality of routes from the current location of the vehicle 1 to home which are created by each of a plurality of different route search conditions.

In the case of displaying the source menu screen corresponding to the item 83 relative to the route condition change on the second display section 16, the control device 17 displays on the first display section 15 the map image which has the plurality of routes from the current location of the vehicle 1 to the destination which are created by each of the plurality of different route search conditions.

In the case of displaying the source menu screen corresponding to the item 84 relative to the registered point list on the second display section 16, the control device 17 displays a map image having a plurality of registered points on the first display section 15.

In the case of displaying the source menu screen corresponding to the item 85 relative to the route deletion on the second display section 16, the control device 17 displays a map image having the route point selected at present time on the first display section 15.

The interrupt screen is a screen which is changed from the resident screen in the predetermined condition. The interrupt screen is a rear camera image screen W10 displaying an imaged image of the rear of the vehicle 1 which is imaged by the rear camera 21 or an incoming call screen W11 for informing the arrival of the incoming call of the cellular phone 24 or the like, for example.

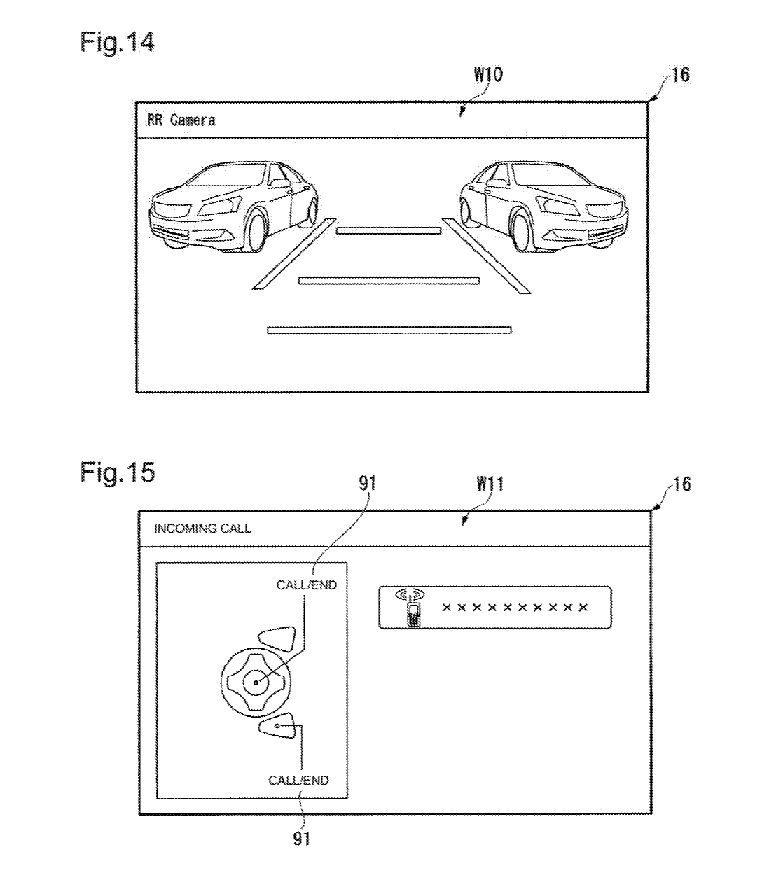

When it is detected by the shift position sensor 13 that the shift position is a reverse position, the control device 17 displays a rear camera image screen W10 on the second display section 16, as shown in FIG. 14. The rear camera image screen W10 may have the information indicating that the reverse position of the shift position is selected by the select lever 50, in addition to the imaged image of the rear of the vehicle 1. When it is detected by the shift position sensor 13 that the shift position is shifted from the reverse position to a position other than the reverse position, the control device 17 switches the rear camera image screen W10 of the second display section 16 to the screen just before the rear camera image screen W10 is displayed.

As shown in FIG. 15, when the incoming call is caused in the cellular phone 24, the control device 17 displays an incoming call screen W11 on the second display section 16. The incoming call screen W11 has the information such as telephone number of the originator, the information (operation guide) for guiding operation of the incoming call, and the like, for example. The information for guiding the operation of the incoming call is, for example, the information for guiding by symbols or characters the operation of the incoming call corresponding to operable parts among each of parts of the steering switch 11 in the image indicating the steering switch 11. In the incoming call screen shown in FIG. 15, the operable parts among each of the parts of the steering switch 11 are the first push button (SOURCE) 42 and the second push button (MENU) 43. Characters for guiding the operation of the telephone communication start or the telephone communication end relative to the incoming call are provided to correspond to the first push button (SOURCE) 42 and the second push button (MENU) 43. The characters 91 for guiding the operation state of the first push button (SOURCE) 42 and the second push button (MENU) 43 are characters such as “CALL/END”, for example.

When the telephone communication (call) relative to the incoming call of the cellular phone 24 is ended, the control device 17 switches the incoming call screen W11 of the second display section 16 to the screen just before the incoming call screen W11 is displayed.

The control device 17 exchanges at least a part of the display contents of the first display section 15 and the at least a part of the display contents of the second display section 16 in the second display mode, for example. In the second display mode, the control device 17 displays any one of the resident screen, the steering switch menu screen and the interrupt screen for example, on the first display section 15. In the second display mode, the control device 17 displays on the second display section 16 the navigation screen which has the map image corresponding to the display contents of the first display section 15, and the like, for example.

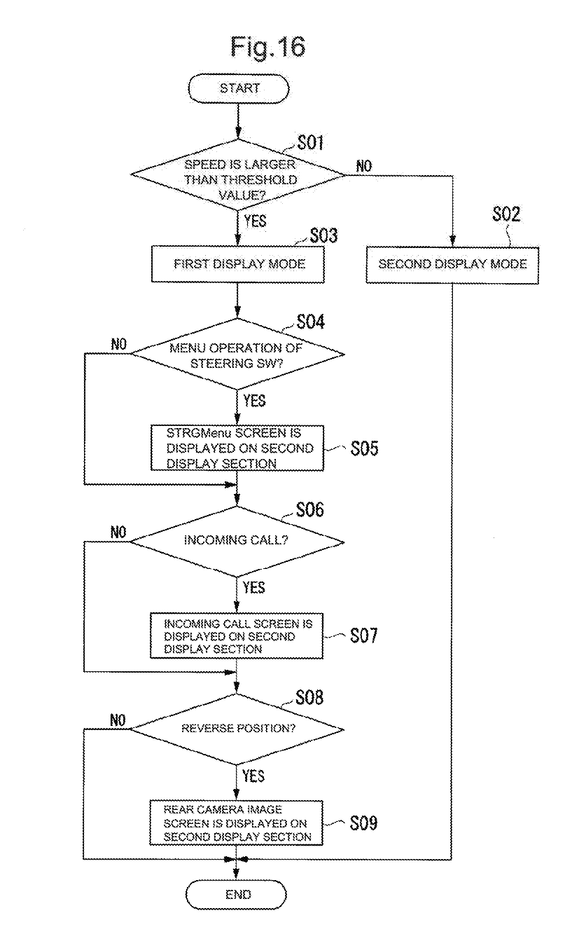

The display device 10 for the vehicle according to this embodiment is provided with the above described configuration. Next, the operation of the display device 10 for the vehicle will be explained with reference to FIG. 16.

The control device 17 executes repeatedly on a predetermined cycle, etc. processes from step S01 to step S09 which are shown below.

The control device 17 determines whether or not the vehicle speed is larger than the threshold value (step S01).

When the determination result is “NO”, the control device 17 advances the process to step S02 (the side of NO of step S01).

On the other hand, when the determination result is “YES”, the control device 17 advances the process to step S03 (the side of YES of step S01).

The control device 17 executes the second display mode, and the process is advanced to an END (step S02).

The control device 17 executes the first display mode (step S03).

The control device 17 determines whether or not the second push button (MENU) 43 of the steering switch 11 is operated (step S04).

When the determination result is “NO”, the control device 17 advances the process to step S06 (the side of NO of step S04).

On the other hand, when the determination result is “YES”, the control device 17 advances the process to step S05 (the side of YES of step S04).

The control device 17 displays the steering switch menu (STRGMenu) screen on the second display section 16 (step S05).

The control device 17 determines whether or not the incoming call is caused in the cellular phone 24 (step S06).

When the determination result is “NO”, the control device 17 advances the process to step S08 (the side of NO of step S06).

On the other hand, when the determination result is “YES”, the control device 17 advances the process to step S07 (the side of YES of step 06).

The control device 17 displays the incoming call screen on the second display section 16 (step S07).

The control device 17 determines whether or not the shift position is the reverse position (step S08).

When the determination result is “NO”, the control device 17 advances the process to the END (the side of NO of step S08).

On the other hand, when the determination result is “YES”, the control device 17 advances the process to step S09 (the side of YES of step 08).

The control device 17 displays the rear camera image screen on the second display section 16 (step S09). Then, the control device 17 advances the process to the END.

As explained above, the display device 10 of the vehicle according to this embodiment has the control device 17 which displays the operation states of the steering switch 11 on the second display section 16 during traveling of the vehicle 1. Therefore, the operation states of the steering switch 11 can be easily confirmed by the operator while ensuring the visibility relative to the display contents such as the map of the first display section 15, and the like.

Further, even when it is difficult for the operator during operation of the vehicle 1 to visually confirm directly the operation states of the steering switch 11, the operation states of the steering switch 11 can be easily confirmed through the second display section 16 by the operator.

Further, since the control device 17 highlights and displays the actual operation state of the steering switch 11, the operation states of the steering switch 11 can be easily confirmed by the operator even during the operation of the vehicle 1.

Further, since the second display section 16 is arranged in the position which is visually confirmed more easily than the first display section 15 by the operator, the operation state of the steering switch 11 can be easily confirmed by the operator even during the operation of the vehicle.

Further, the control device 17 controls the display contents of the second display section 16 such that the display contents fall within a range of the single screen. Therefore, in comparison with the case where the screen feed or scrolling, for example, is required, it is possible to prevent the operator's attention from becoming distracted, and the increase in movement of the sight line can be prevented.

Accordingly, since the list of the destination histories is displayed in such a manner as to fall within a range of the single screen, it is possible to prevent the operator's attention from becoming distracted, at the time of setting the destination, etc.

Further, since the map around the position such as the destination or the registered point or the like to be displayed by the second display section 16 is displayed on the first display section 15, the visibility relative to the map can be easily ensured, and the position can be easily grasped by the operator.

Further, since the control device 17 displays on the second display section 16 the operation guide for telephonic communication at the time of the incoming call of the cellular phone 24, the cellular phone 24 can be easily operated by the steering switch 11 without getting the operator confused even when operating the vehicle.

Further, in the case where the operator can afford to visually confirm directly the operation state of the steering switch 11 at the time of stopping the vehicle 1, etc., the information other than the operation states of the steering switch 11 can be displayed on the second display section 16 by exchanging the display contents of the first display section 15 and the display contents of the second display section 16.

A modified example of the above described embodiment will be explained hereunder.

In the above described embodiment, although the display device 10 for the vehicle has the first display section 15 and the second display section 16 which are arranged in the instrument panel 51, it is not limited thereto.

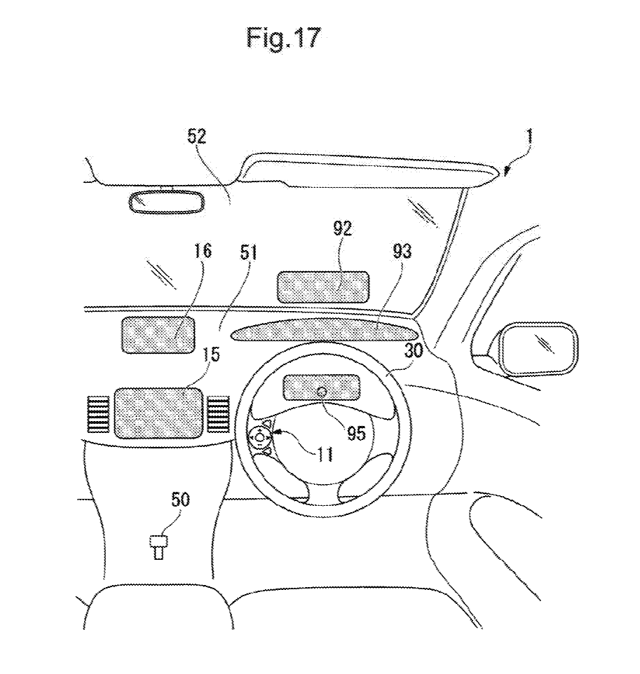

Instead of a combination of the first display section 15 and the second display section 16, the display device 10 for the vehicle may have any combination of two display sections among a plurality of display sections shown in FIG. 17. The plurality of display sections include, for example, a HUD (head up display) device 92, a MID (multi information display) device 93, an in-wheel area display 94 and the like in addition to either of the first display section 15 and the second display section 16.

The HUD device 92 projects and displays the image on the front glass 52 in front of a driver's seat or displays the image in the form of a virtual image above the instrument panel 51 in front of the driver's seat, for example.

The MID device 93 is arranged in a meter panel part which is provided with meters such as a speed meter located in the instrument panel 51 in front of the driver's seat, for example.

The in-wheel area display 94 is arranged in the upper part of the steering wheel 30, for example.

The HUD device 92 or the MID device 93 is arranged in a position which is more visible than the second display section 16 from the operator of the vehicle 1. The second display section 16 is arranged in a position which is visually confirmed more easily than the first display section 15 by the operator of the vehicle 1. Instead of the combination of the first display section 15 and the second display section 16 in the above describe embodiment, the HUD device 92 or the MID device 93 and the second display 16 may be combined, or alternatively, the HUD device 92 or the MID device 93 and the first display section 16 may be combined, for example.

In the above described embodiment, the display device 10 may be provided with a lamp body such as an LED lamp, etc. indicating that the steering switch 11 is operated. The lamp body is arranged in the instrument panel 51 or the steering wheel 30 or the like, for example. The lamp body informs the operator that the steering switch 11 is operated, when it is lit on at the time each of the parts of the steering switch 11 is operated. For example, in the vehicle 1 shown in FIG. 17, the lamp body 95 is arranged in the steering wheel 30.

In the above described embodiment, the control device 17 executes the first display mode in the case where the vehicle speed detected by the vehicle speed sensor 12 during traveling of the vehicle 1 is larger than the predetermined threshold value, but it is not limited thereto. The control 17, in spite of the speed of the vehicle 1, device may execute the first display mode at all times and may not execute the second display mode. The second display section 16 at that time may not be the touch panel and may not receive the operation by the operator's fingers.

In the above described embodiment, in the steering switch menu screen, the information of the operation contents corresponding to the actually operated part of the steering switch 11, and the item to be selected by the operation of the steering switch 11 are highlighted and displayed, but it is not limited thereto.

The control device 17, in the steering switch menu screen, may highlight and display the information of the operation contents corresponding to the operable parts of the steering switch 11.

The control device 17, in the steering switch menu screen, may display the information of the operable directions among the plurality of items to be selected by the operation of the steering switch 11. For example, in the main menu screen W5 shown in FIG. 8 of the above described embodiment, the control device 17 may display the information of the lower direction to be addressed to the item (Navigation Menu) 72 relative to the navigation system 22 from the item (Audio Menu) 71 relative to the audio device 23, as the operable direction among the plurality of items 71 to 74.

In the above described embodiment, a part or whole of the control device 17 may be a functional part which functions when a CPU (Central Processing Unit) executes the program. Further, these configurations may be realized as an integrated circuit such as an LSI (Large Scale Integration), etc. Moreover, each of functional blocks of these configurations may be in the form of a processor separately, and a part or whole thereof may be integrated into a processor. Further, an integrated circuit technique is not limited to the LSI, and may be realized as a specialized circuit or generalized processor. In addition, in the case where an alternative integrated circuit technique appears with progress in semiconductor technology, the integrated circuit based on such technique may be used.

The embodiment of the present invention is proposed as an example and does not intend to limit the scope of the invention. These embodiments may be embodied in various configurations, and various deletions, rearrangements and changes may be made without departing from the scope of the gist of the invention. These embodiments and modifications thereof may be included within the scope and gist of the invention and within the inventions and equivalents thereof described in claims.

### DESCRIPTION OF REFERENCE CHARACTERS

1: Vehicle, 10: Display device for vehicle, 11: Steering switch (Operating section, switch), 12: Vehicle speed sensor (Vehicle speed detection section), 13: Sift position sensor, 15: First display section: 16: Second display section, 17: Control device (Control section), 21: Rear camera, 22: Navigation system, 23: Audio device, 24: Cellular phone (Telephone), 50: Select lever (Operation section).

1. A display device for a vehicle, comprising:
a first display section configured to display at least a map;
a second display section configured to display information for operating a display content of the first display section;
an operation section arranged in a position other than a vicinity of the first display section and other than a vicinity of the second display section and configured to receive an operation input inputted by the operator, thereby changing an operation state of the operation section;
a vehicle speed detection section configured to detect a speed of the vehicle; and
a control section configured to control the second display section so as to display information of the operation state of the operation section on the second display section when the vehicle speed detected by the vehicle speed detection section is larger than a threshold value.

2. The display device for the vehicle according to claim 1, wherein the operation section comprises a switch arranged in a steering wheel of the vehicle.

3. The display device for the vehicle according to claim 2, wherein the control section configured to display a plurality of different operation states selectable by the operation input and highlight only the operation state actually selected by the operation input among the plurality of different operation states.

4. The display device for the vehicle according to claim 1, wherein the second display section is arranged in a position which is visually confirmed more easily than the first display section by the operator.

5. The display device for the vehicle according to claim 1, wherein the control section controls a display content of the second display section such that the display content of the second display section is displayed in a single screen.

6. The display device for the vehicle according to claim 5, wherein the control section allows the second display section to display a list of destination histories related to an operation of the first display section.

7. The display device for the vehicle according to claim 5, wherein the control section allows the second display section to display a list of registered locations related to the map.

8. The display device for the vehicle according to claim 7, wherein the second display section displays any one of the locations, and the control section allows the first display section to display a local area map around the location displayed in the second display section.

9. The display device for the vehicle according to claim 1, wherein the control section allows the second display section to display an operation guide for telephonic communication at a time of an incoming telephone call which is operable by the operation section.

10. The display device for the vehicle according to claim 1, wherein the control section allows the display content of the first display section and a display content of the second display section to be exchanged such that the display content of the first display section is displayed in the second display section and the display content of the second display section is displayed in the first display section when the speed of the vehicle detected by the vehicle speed detection section is smaller than or equal to the threshold value.

11. A display device for a vehicle, comprising:
a first display section configured to display at least a map;
a second display section configured to display information for operating a display content of the first display section;
an operation section comprising a switch arranged in a steering wheel and configured to receive an operation input inputted by an operator via the switch, thereby switching an operation state of the operation section; and
a control section configured to control the second display section to display thereon an illustration corresponding to a form of the switch and indicate information of the operation state of the operation section in the form of the switch.
